(19) United States
(12) Patent Application Publication
(10) Pub. No.: US 2018/0239871 A1
(43) Pub. Date: Aug. 23, 2018

(54) Prioritization of Clinical Data for Visual Display

(71) Applicant: International Business Machines Corporation, Armonk, NY (US)

(72) Inventors: Ella Barkan, Haifa (IL); Sharbell Hashoul, Haifa (IL); Pavel Kisilev, Maalot (IL); Eugene Walach, Haifa (IL)

(21) Appl. No.: 15/436,883

(22) Filed: Feb. 20, 2017

(51) Int. Cl. G06F 19/00

(52) U.S. Cl. CPC G06F 19/345; G06F 19/321; G06F 19/324

(57) ABSTRACT

Processing a chief medical complaint, associated with a patient, together with current clinical data items derived from current clinical data associated with the patient to establish a baseline medical diagnosis of the patient, for each of different historical clinical data items derived from historical clinical data associated with the patient, processing the chief medical complaint together with the current clinical data items and the historical clinical data item to establish a comparison medical diagnosis of the patient, where the comparison medical diagnosis results from an diagnostic effect of the historical clinical data item on the baseline medical diagnosis, and determining the diagnostic effect of each of the historical clinical data items on the baseline medical diagnosis, and visually displaying on a visual display medium any of the historical clinical data items in accordance with a prioritization arrangement based on the diagnostic effects of the historical clinical data items.

### BACKGROUND

When diagnosing a patient and deciding upon treatment, a physician often studies the patient's past and present clinical data, including image-based and text-based clinical data. However, as the amount of these data increases over time, so too does the difficulty and time required for their review.

### SUMMARY

In one aspect of the invention a method is provided for visually displaying clinical data, the method including processing a chief medical complaint, associated with a patient, together with current clinical data items derived from current clinical data associated with the patient to establish a baseline medical diagnosis of the patient, for each of different historical clinical data items derived from historical clinical data associated with the patient, processing the chief medical complaint together with the current clinical data items and the historical clinical data item to establish a comparison medical diagnosis of the patient, where the comparison medical diagnosis results from an diagnostic effect of the historical clinical data item on the baseline medical diagnosis, and determining the diagnostic effect of each of the historical clinical data items on the baseline medical diagnosis, and visually displaying on a visual display medium any of the historical clinical data items in accordance with a prioritization arrangement based on the diagnostic effects of the historical clinical data items.

In other aspects of the invention systems and computer program products embodying the invention are provided.

### BRIEF DESCRIPTION OF THE DRAWINGS

Aspects of the invention will be understood and appreciated more fully from the following detailed description taken in conjunction with the appended drawings in which:

FIG. 1 is a simplified conceptual illustration of a system for visually displaying clinical data, constructed and operative in accordance with an embodiment of the invention;

FIG. 2 is a simplified flowchart illustration of an exemplary method of operation of the system of FIG. 1, operative in accordance with various embodiments of the invention; and

FIG. 3 is a simplified block diagram illustration of an exemplary hardware implementation of a computing system, constructed and operative in accordance with an embodiment of the invention.

### DETAILED DESCRIPTION

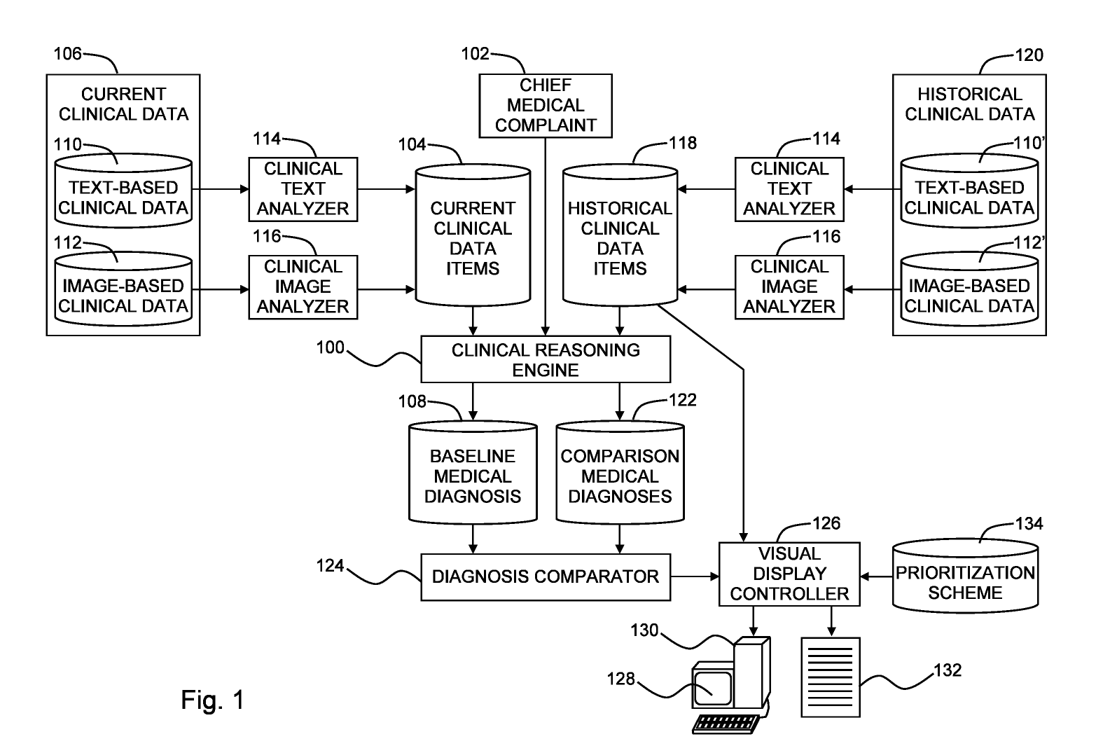

Reference is now made to FIG. 1, which is a simplified conceptual illustration of a system for visually displaying clinical data, constructed and operative in accordance with an embodiment of the invention. In the system of FIG. 1, a clinical reasoning engine 100 is configured to process a chief medical complaint 102 associated with a patient together with current clinical data items 104 derived from current clinical data 106 associated with the patient, thereby establishing a baseline medical diagnosis 108 of the patient. Clinical reasoning engine 100 may employ any known techniques to establish baseline medical diagnosis 108, such as are described in S. Hashoul, et al., Efficacy of an Automatic Decision Support System in Facilitating Diagnosis of Breast Diseases, DOI 10.1594/ecr2016/C-2396, ECR 2016, European Congress of Radiology, Vol. C-2396. Chief medical complaint 102 may be determined in accordance with conventional techniques, such as are described in Y. Jernite, et al., Predicting Chief Complaints at Triage Time in the Emergency Department. NIPS 2013 Workshop on Machine Learning for Clinical Data Analysis and Healthcare, December 2013. Chief medical complaint 102 may, for example, be an actual complaint by the patient, or simply a routine screening.

Current clinical data 106 preferably includes text-based clinical data 110, such as physicians' notes, patient temperature and blood pressure data, as well as image-based clinical data 112, such as radiological images, CAT images, and PET images. In one embodiment current clinical data items 104 are derived from text-based clinical data 110 by a clinical text analyzer 114 configured to derive current clinical data items 104 from text-based clinical data 110 in accordance with conventional techniques, such as are used by MetaMap™, a tool for recognizing UMLS concepts in text, available from The National Institutes of Health (NIH) of the United States Department of Health and Human Services, Bethesda, Md. In one embodiment current clinical data items 104 are derived from image-based clinical data 112 by a clinical image analyzer 116 configured to derive current clinical data items 104 from image-based clinical data 112 in the form of semantic descriptors of visual image characteristics of image-based clinical data 112, where clinical image analyzer 116 operates in accordance with conventional techniques, such as are described in P. Kisilev, et al., Semantic Description of Medical Image Findings: Structured Learning Approach, Proceedings of the British Machine Vision Conference 2015, Swansea, UK, Sep. 7-10, 2015, pages 171.1-171.11. Current clinical data items 104 preferably include data derived from both text-based clinical data 110 and image-based clinical data 112.

Baseline medical diagnosis 108 preferably includes one or more diagnoses, where multiple diagnoses are preferably ranked by the likelihood that each diagnosis is correct.

Clinical reasoning engine 100 is further configured to process one or more historical clinical data items 118 derived from historical clinical data 120 associated with the patient, together with chief medical complaint 102 and current clinical data items 104, thereby establishing a comparison medical diagnosis 122 of the patient. Historical clinical data 120 preferably includes text-based clinical data 110′ as well as image-based clinical data 112′, where historical clinical data items 118 are derived from text-based clinical data 110′ by clinical text analyzer 114 and from image-based clinical data 112′ by clinical image analyzer 116 as described above, where historical clinical data items 118 preferably include data derived from both text-based clinical data 110′ and image-based clinical data 112′.

In one embodiment, clinical reasoning engine 100 processes, in each of multiple iterations, a different one of historical clinical data items 118, such as where they are processed in their chronological order, together with chief medical complaint 102 and current clinical data items 104, thereby producing in each iteration a different instance of comparison medical diagnosis 122 for each different historical clinical data item 118 that is processed. In one embodiment, each iteration processes only one of historical clinical data items 118. In another embodiment, each iteration processes one additional historical clinical data item 118 together with any previously-processed historical clinical data items 118, where the additional historical clinical data item 118 is associated with the comparison medical diagnosis 122 produced during that iteration. Each instance of comparison medical diagnosis 122 is thus the result of the diagnostic effect of its associated historical clinical data item 118 on baseline medical diagnosis 108.

A diagnosis comparator 124 is configured to determine the diagnostic effect of each of the historical clinical data items 118 on baseline medical diagnosis 108. In one embodiment, diagnosis comparator 124 determines Kendall tau rank distance, such as is described in M. Kendall, “A New Measure of Rank Correlation,” Biometrika, 30: 81-89, 1938, in which a count is made of the number of pairwise disagreements between two ranking lists to determine the degree of dissimilarity between the lists. In this embodiment, each of the comparison medical diagnoses 122 that is produced as described above for a given historical clinical data item 118 is separately paired with baseline medical diagnosis 108, and diagnosis comparator 124 determines for each such pairing a degree of dissimilarity between baseline medical diagnosis 108 and comparison medical diagnosis 122. Each such degree of dissimilarity thus corresponds to a different historical clinical data item 118, and is thus used to represent the diagnostic effect of the historical clinical data item 118 on baseline medical diagnosis 108.

A visual display controller 126 is configured to visually display on a visual display medium, such as on a computer display 128 of a computer 130 or in a printed report 132, any of historical clinical data items 118 in accordance with a prioritization scheme 134 that is based on the diagnostic effects of historical clinical data items 118. In one embodiment, visual display controller 126 is configured to visually display any of historical clinical data items 118 more prominently than other historical clinical data items 118 where the diagnostic effects of the more prominently displayed historical clinical data items 118 are greater than the diagnostic effects of the other historical clinical data items 118. In another embodiment, visual display controller 126 is configured to visually display any of historical clinical data items 118 whose diagnostic effect exceeds a minimum value. In another embodiment, visual display controller 126 is configured to visually display any of historical clinical data items 118 in descending order of their diagnostic effect.

Visual display controller 126 is preferably configured to visually display any of historical clinical data items 118, as described hereinabove, optionally together with any of their related historical clinical data 120, in a manner that is distinct from concurrent visual display of any of clinical data items 104 and/or their related current clinical data 106, such as in separate windows on computer display 128.

Any of the elements shown in FIG. 1 are preferably implemented by one or more computers in computer hardware and/or in computer software embodied in a non-transitory, computer-readable medium in accordance with conventional techniques, such as where any of the elements shown in FIG. 1 are hosted by computer 130.

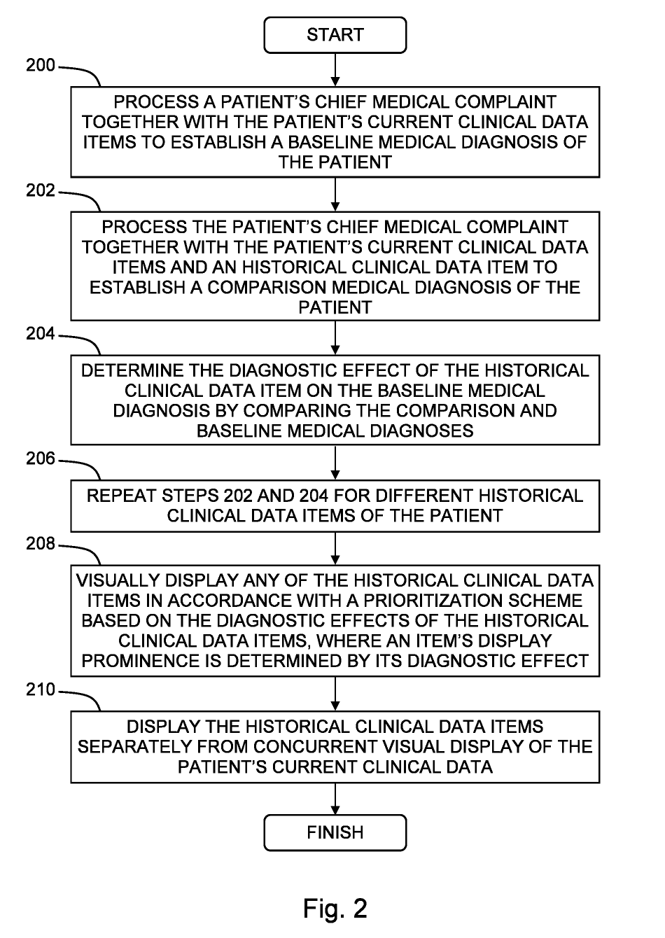

Reference is now made to FIG. 2, which is a simplified flowchart illustration of an exemplary method of operation of the system of FIG. 1, operative in accordance with an embodiment of the invention. In the method of FIG. 2, a chief medical complaint associated with a patient is processed together with one or more current clinical data items derived from current clinical data associated with the patient, thereby establishing a baseline medical diagnosis of the patient (step 200). The chief medical complaint is processed together with the current clinical data items and an historical clinical data item derived from the historical clinical data associated with the patient, thereby establishing a comparison medical diagnosis of the patient (step 202). The diagnostic effect of the historical clinical data item on the baseline medical diagnosis is determined by comparing the comparison and baseline medical diagnoses (step 204). Steps 202 and 204 are repeated for each of the historical clinical data items derived from the historical clinical data associated with the patient (step 206). Any of the historical clinical data items are visually displayed in accordance with a prioritization scheme that is based on the diagnostic effects of the historical clinical data items, with historical clinical data items having a greater diagnostic effect being visually displayed more prominently than historical clinical data items having a lesser diagnostic effect, such as where the historical clinical data items are visually displayed in descending order of their diagnostic effect (step 208). The historical clinical data items are displayed, optionally together with any of their related historical clinical data, in a manner that is distinct from concurrent visual display of any of the current clinical data items and/or their related current clinical data (step 210).

The operation of the system of FIG. 1 and method of FIG. 2 is demonstrated in the context of the following exemplary scenario in which a 63-year-old female presents for a routine mammogram screening. The patient's medical history includes: leg and hand fractures in the previous year, a cataract operation two years prior, a pulmonary embolism three years prior, and multiple abdominal polyps excisions and Gardner syndrome detected four years prior. The patient's mammogram reveals a mass that the patient's radiologist at first suspects might be a malignancy.

Conventional analysis techniques are employed to derive current clinical data items from the patient's current clinical data, i.e., the patient's mammogram, including radiological characteristics of the mass, including of its shape, margins, and density.

The patient's chief complaint, i.e., mammography screening, and the patient's current clinical data items, i.e., radiological characteristics, are processed as described hereinabove to produce the following baseline diagnosis ranked in order of likelihood:

1. Breast Carcinomas (>10 different types)

2. Fibroadenoma

3. Breast Papilloma

4. Complex breast cysts

5. Fibromatosis

The patient's chief complaint and current clinical data items are then processed as described hereinabove together with the patient's historical clinical data items in multiple iterations to produce multiple comparison diagnoses, where the historical clinical data items include (in chronological order, most recent to oldest):

1. Leg fracture

2. Hand fracture

3. Cataract operation

4. Pulmonary embolism

5. Excision of abdominal polyps

6. Gardner Syndrome

Thus, in one iteration, the patient's chief complaint and current clinical data items are processed together with the historical clinical data item of ‘leg fracture’ to produce a comparison diagnosis that is associated with the additional consideration of the patient's leg fracture, while in another iteration the patient's chief complaint and current clinical data items are processed together with the historical clinical data item of ‘hand fracture’ to produce a comparison diagnosis that is associated with the additional consideration of the patient's hand fracture. This process is repeated for each of the patient's other historical clinical data items.

The comparison diagnosis produced during each iteration is compared with the baseline diagnosis to determine the diagnostic effect that an historical clinical data item has on the baseline diagnosis. In the current example, the comparison diagnoses are identical to the baseline diagnosis with the exception of the following comparison diagnosis associated with the additional consideration of the patient's Gardner Syndrome, ranked in order of likelihood:

1. Fibromatosis

2. Breast Carcinomas (>10 different types)

3. Fibroadenoma

4. Breast Papilloma

5. Complex breast cysts

The patient's historical clinical data items are visually displayed on a computer display in accordance with a prioritization scheme that is based on the diagnostic effects of the historical clinical data items. In this example, “Gardner Syndrome” is displayed prominently above the other historical clinical data items, and as a selectable link to indicate that its associated comparison diagnosis differs from the baseline diagnosis, as follows:

1. Gardner Syndrome

2. Leg fracture

3. Hand fracture

4. Cataract operation

5. Pulmonary embolism

6. Excision of abdominal polyps

The patient's mammogram is displayed separately on the computer screen as well, as is the baseline diagnosis.

The radiologist sees that “Gardner Syndrome” is prominently displayed among the patient's other historical clinical data items. Knowing that Gardner Syndrome is associated with fibromatosis, a symptom of which is the presence of benign dismoid tumors, the radiologist decides that it is more likely that the mass is benign rather than malignant. The radiologist selects “Gardner Syndrome,” causing its associated comparison diagnosis to be separately displayed on the computer screen, whereupon the radiologist sees that fibromatosis is indeed the most likely diagnosis. Consequently, the radiologist does not order a biopsy, but instead schedules a follow-up appointment for the patient to be reevaluated at a later date.

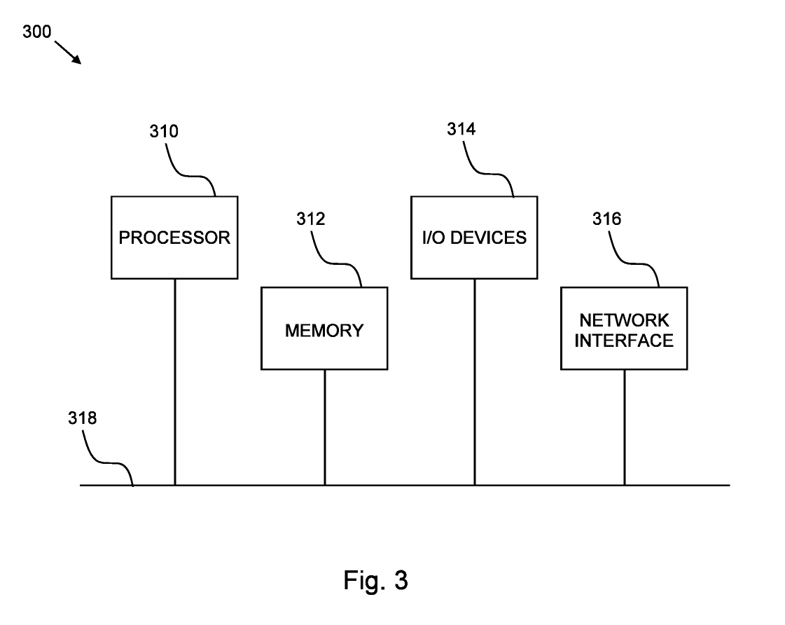

Referring now to FIG. 3, block diagram 300 illustrates an exemplary hardware implementation of a computing system in accordance with which one or more components/methodologies of the invention (e.g., components/methodologies described in the context of FIGS. 1-2) may be implemented, according to an embodiment of the invention. As shown, the invention may be implemented in accordance with a processor 310, a memory 312, I/O devices 314, and a network interface 316, coupled via a computer bus 318 or alternate connection arrangement.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

Embodiments of the invention may include a system, a method, and/or a computer program product. The computer program product may include a computer readable storage medium (or media) having computer readable program instructions thereon for causing a processor to carry out aspects of the invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the invention.

Aspects of the invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for visually displaying clinical data, the method comprising:
processing a chief medical complaint, associated with a patient, together with current clinical data items derived from current clinical data associated with the patient, thereby establishing a baseline medical diagnosis of the patient;
for each of a plurality of historical clinical data items derived from historical clinical data associated with the patient,
processing the chief medical complaint together with the current clinical data items and the historical clinical data item, thereby establishing a comparison medical diagnosis of the patient, wherein the comparison medical diagnosis results from an diagnostic effect of the historical clinical data item on the baseline medical diagnosis, and
determining the diagnostic effect of each of the historical clinical data items on the baseline medical diagnosis; and
visually displaying on a visual display medium any of the historical clinical data items in accordance with a prioritization arrangement based on the diagnostic effects of the historical clinical data items.

2. The method according to claim 1 and further comprising deriving the clinical data items from text-based clinical data.

3. The method according to claim 1 and further comprising deriving the clinical data items from image-based clinical data in the form of semantic descriptors of visual image characteristics of the image-based clinical data.

4. The method according to claim 1 wherein the processing comprises processing using a clinical reasoning engine.

5. The method according to claim 1 wherein the visually displaying comprises visually displaying a first one of the historical clinical data items more prominently than a second one of the historical clinical data items wherein the diagnostic effect of the first one of the historical clinical data items is greater than the diagnostic effect of the second one of the historical clinical data items.

6. The method according to claim 1 wherein the visually displaying comprises visually displaying any of the historical clinical data items whose diagnostic effect exceeds a minimum value.

7. The method according to claim 1 wherein the visually displaying comprises visually displaying the historical clinical data items in descending order of their diagnostic effect.

8. The method according to claim 1 wherein the processing, determining, and visually displaying are implemented in any of
a) computer hardware, and
b) computer software embodied in a non-transitory, computer-readable medium.

9. A system for visually displaying clinical data, the system comprising:
a clinical reasoning engine configured to
process a chief medical complaint, associated with a patient, together with current clinical data items derived from current clinical data associated with the patient, thereby establishing a baseline medical diagnosis of the patient, and
for each of a plurality of historical clinical data items derived from historical clinical data associated with the patient, to process the chief medical complaint together with the current clinical data items and the historical clinical data item, thereby establishing a comparison medical diagnosis of the patient, wherein the comparison medical diagnosis results from an diagnostic effect of the historical clinical data item on the baseline medical diagnosis;
a diagnosis comparator configured to determine the diagnostic effect of each of the historical clinical data items on the baseline medical diagnosis; and
a visual display controller configured to visually display on a visual display medium any of the historical clinical data items in accordance with a prioritization arrangement based on the diagnostic effects of the historical clinical data items.

10. The system according to claim 9 and further comprising a clinical text analyzer configured to derive the clinical data items from text-based clinical data.

11. The system according to claim 9 and further comprising a clinical image analyzer configured to derive the clinical data items from image-based clinical data in the form of semantic descriptors of visual image characteristics of the image-based clinical data.

12. The system according to claim 9 wherein the visual display controller is configured to visually display a first one of the historical clinical data items more prominently than a second one of the historical clinical data items wherein the diagnostic effect of the first one of the historical clinical data items is greater than the diagnostic effect of the second one of the historical clinical data items.

13. The system according to claim 9 wherein the visual display controller is configured to visually display any of the historical clinical data items whose diagnostic effect exceeds a minimum value.

14. The system according to claim 9 wherein the visual display controller is configured to visually display the historical clinical data items in descending order of their diagnostic effect.

15. The system according to claim 9 wherein the clinical reasoning engine, diagnosis comparator, and visual display controller are implemented in any of
a) computer hardware, and
b) computer software embodied in a non-transitory, computer-readable medium.

16. A computer program product for visually displaying clinical data, the computer program product comprising:
a non-transitory, computer-readable storage medium; and
computer-readable program code embodied in the storage medium, wherein the computer-readable program code is configured to
process a chief medical complaint, associated with a patient, together with current clinical data items derived from current clinical data associated with the patient, thereby establishing a baseline medical diagnosis of the patient, and
for each of a plurality of historical clinical data items derived from historical clinical data associated with the patient, process the chief medical complaint together with the current clinical data items and the historical clinical data item, thereby establishing a comparison medical diagnosis of the patient, wherein the comparison medical diagnosis results from an diagnostic effect of the historical clinical data item on the baseline medical diagnosis,
determine the diagnostic effect of each of the historical clinical data items on the baseline medical diagnosis, and
visually display on a visual display medium any of the historical clinical data items in accordance with a prioritization arrangement based on the diagnostic effects of the historical clinical data items.

17. The computer program product according to claim 16 wherein the computer-readable program code is configured to derive the clinical data items from text-based clinical data.

18. The computer program product according to claim 16 wherein the computer-readable program code is configured to derive the clinical data items from image-based clinical data in the form of semantic descriptors of visual image characteristics of the image-based clinical data.

19. The computer program product according to claim 16 wherein the computer-readable program code is configured to visually display a first one of the historical clinical data items more prominently than a second one of the historical clinical data items wherein the diagnostic effect of the first one of the historical clinical data items is greater than the diagnostic effect of the second one of the historical clinical data items.

20. The computer program product according to claim 16 wherein the computer-readable program code is configured to visually display any of the historical clinical data items whose diagnostic effect exceeds a minimum value.
